(19) United States
(12) Patent Application Publication
(10) Pub. No.: US 2009/0150459 A1
(43) Pub. Date: Jun. 11, 2009

(54) HIGHLY AVAILABLE MULTIPLE STORAGE SYSTEM CONSISTENCY HEARTBEAT FUNCTION

(75) Inventors: David R. Blea, Tucson, AZ (US); Todd B. Schlomer, Westminster, CO (US)

Correspondence Address: OPPENHEIMER, WOLFF & DONNELLY, LLP, PLAZA VII, SUITE 3300, 45 SOUTH SEVENTH STREET, MINNEAPOLIS, MN, 55402-1609, US

(73) Assignee: International Business Machines Corporation, Armonk, NY (US)

(21) Appl. No.: 11/952,339

(22) Filed: Dec. 7, 2007

(51) Int. Cl. G06F 17/30

(52) U.S. Cl. 707/204; 707/E17.005

(57) ABSTRACT

The present invention provides for a method and system for performing a high availability consistency heartbeat function from multiple consistency managers in a networked data storage system. A secondary consistency manager is utilized to send a heartbeat and manage data replication if the primary consistency manager is unable to successfully send a heartbeat to the replicating storage devices. The secondary consistency manager sends this heartbeat with an identifier identical to the heartbeat previously sent by the primary consistency manager. When the primary consistency manager returns to the network, it can resume its active, controlling role, or the primary consistency manager may swap roles with the now-active secondary consistency manager.

### FIELD OF THE INVENTION

The present invention generally relates to data storage systems operating over a computer network. The present invention specifically relates to a data storage system utilizing a subsystem which attempts to maintain the consistency of mirrored data stored in multiple storage devices in a high availability environment.

### BACKGROUND OF THE INVENTION

Data mirroring systems, also known as storage consistency systems, are used to replicate data from a source storage device to one or more target storage devices. These systems allow redundant copies of data to be preserved for safekeeping or to recover from lost or damaged data. Many storage consistency systems manage the data mirroring process by copying data from a source device to a target device immediately after it is written, performing synchronization and updates of the data on the target device in the order that it is written on the source device. To ensure that data is continually mirrored, current systems employ some form of a consistency manager, often in the form of software operating on a server which manages the data replication by issuing commands to start, stop, or suspend the data replication from the source storage device to the corresponding target storage devices.

Some implementations of a consistency manager utilize a “heartbeat” which is sent to the storage device to help detect if the consistency manager has failed. This heartbeat may be implemented by sending a signal from the consistency manager to the storage devices at some predefined interval. If the source storage device does not receive the heartbeat within a timeout period that is slightly longer than the predefined interval, then the device will presume that the consistency manager has failed. The source storage device will then issue a data “freeze” to stop writing additional data on its volume. This freeze prevents data from being added, deleted, or modified on the source storage device without being replicated on the target storage device.

While a heartbeat sent between a consistency manager and the source storage device allows the source storage devices to be easily informed of the data replication status, the system will stop functioning if the consistency manager fails. A high availability environment may be desired to utilize multiple consistency manager systems to allow secondary or backup consistency managers to take over the job of managing data replication if the primary consistency manager system fails.

Existing methods of sending a heartbeat from a consistency manager to a source storage device do not function optimally in a high availability environment, however, because multiple consistency managers will each attempt to send a heartbeat to the source storage device. Each consistency manager will employ a distinct heartbeat that the storage devices uses to recognize the consistency manager. In a high availability environment, because there are two or more consistency managers controlling the same set of storage devices, if one of the consistency manager fails, then the source storage device will initiate a freeze because an expected heartbeat was not received by the source storage device. Thus, although there are multiple consistency managers, the entire storage device will freeze if any of the consistency managers fails or is unable to send its heartbeat. This setup contains a single point of failure, which is antithetical to providing a high availability system.

One workaround for utilizing multiple consistency managers is by disabling the heartbeat signal function on the storage devices, so that the storage controllers do not expect a heartbeat signal from a consistency manager. This allows another consistency manager to take over the data replication process, and removes the need for sending a heartbeat. Data replication problems may occur, however, if the active consistency manager fails and the data on the storage device changes before the user enables one of the other inactive consistency managers. Thus, there is a possibility of corrupting the replicated data if an inactive consistency manager is not made active immediately.

What is needed in the art is a way to make multiple consistency managers appear the same to each storage controller that is monitoring for a heartbeat. By allowing multiple consistency managers to send a heartbeat with an identical identifier, a level of redundancy can be introduced to further accomplish high availability of data replication and mirroring.

### BRIEF SUMMARY OF THE INVENTION

The present invention provides a new and unique method and system for facilitating high availability data consistency in multiple storage systems by utilizing two or more consistency manager instances. This method and system allows the underlying data replication process to continue operating even if the primary consistency manager instance fails. The high availability solution in one embodiment of the present invention allows shared identification of the heartbeat sent from the consistency manager instances so that if the primary consistency manager fails, a secondary consistency manager can continue this heartbeat and data replication activities.

In one embodiment of the present invention, a number of source storage devices are replicated on a number of target storage devices. The replication process is managed by a primary consistency manager, which in one embodiment is implemented by storage controlling software operating on a network-connected server. A number of secondary consistency managers are also connected on the network, acting in a passive, standby mode while the primary consistency manager actively manages the data replication process.

During the data replication process, the primary consistency manager sends a signal over the network to the storage controller operating on each source storage device. The signal is sent at predefined, repeated intervals to each source device storage controller, and is referred to further as the “heartbeat”. The heartbeat contains an identifier which is globally unique, this identifier being generated or given to the consistency manager instance when the consistency manager instance starts up. Thus, the heartbeat signal sent from the primary consistency manager contains an unique identifier which would be different from a heartbeat generated by a secondary consistency manager instance. Upon the primary consistency manager taking control of the replication process, the secondary consistency managers and each of the storage devices become aware of the primary consistency manager's unique heartbeat identifier.

The source storage device is configured to pause or freeze writing any additional data if a heartbeat is not received within a predefined timeout period. The source storage device is not concerned where the heartbeat comes from, because the storage device monitors for the receipt of any heartbeat within the heartbeat timeout period. During normal operation, the primary consistency manager is the only consistency manager that sends a heartbeat to the source storage device. None of the secondary consistency managers, which exist in an inactive, standby role, issue a heartbeat until one of the secondary consistency managers becomes activated.

To facilitate high availability, in one embodiment of the present invention, if an interruption occurs to make the primary consistency manager unable to successfully send its heartbeat to the source storage devices, then one of the secondary consistency manager instances will assume the role of the primary consistency manager on the network. This now-activated secondary consistency manager server, which was previously in a standby mode, will continue sending the heartbeat where the previous primary consistency manager server left off to prevent any interruption to the data replication process. To accomplish this, the activated secondary consistency manager will send a heartbeat with the same identifier that was being used by the previous primary consistency manager. The now-activated secondary server will continue data replication operations, and the source storage device will proceed operations as normal, not realizing that a consistency manager has failed.

If the primary consistency manager failed due to a power failure or network failure, then when it returns to the network, it will send a new, unique heartbeat identifier. This will cause the storage controller to treat the old primary and the newly activated consistency manager differently. In one embodiment of the present invention, a user can decide whether to keep the newly activated consistency manager functioning in the primary consistency manager role, or whether to return the activated consistency manager back to an inactive consistency manager role and accordingly return the old primary consistency manager into a active consistency manager role. In another embodiment of the invention, this process can be automated to require minimal user interaction.

By utilizing the heartbeat identifier on a primary consistency manager and a set of secondary consistency manager servers, an inactive consistency manager can take over the active consistency manager role when the source storage device fails to receive the heartbeat from the primary consistency manager for any reason. This allows multiple consistency managers to control the same storage devices at different points in time, without interrupting the storage management software or the data replication process.

### BRIEF DESCRIPTION OF THE DRAWINGS

FIG. 1A illustrates an exemplary operational environment of a highly available multiple storage system utilizing a consistency heartbeat function on a primary consistency manager in accordance with one embodiment of the present invention; and

FIG. 1B illustrates an exemplary operational environment of a highly available multiple storage system utilizing a consistency heartbeat function where the primary consistency manager is disconnected from the network and one of the secondary consistency managers becomes active in accordance with one embodiment of the present invention; and

FIG. 2 illustrates a flowchart representative of the consistency heartbeat method and system operation in accordance with one embodiment of the present invention.

### DETAILED DESCRIPTION OF THE INVENTION

The presently disclosed method and system of a consistency heartbeat function introduces advantages to facilitate the improved operation and consistency of mirrored data in a highly available multiple storage system. In one embodiment of the present invention, high availability functionality is accomplished by utilizing multiple consistency manager replication systems sending a heartbeat with a shared heartbeat identifier.

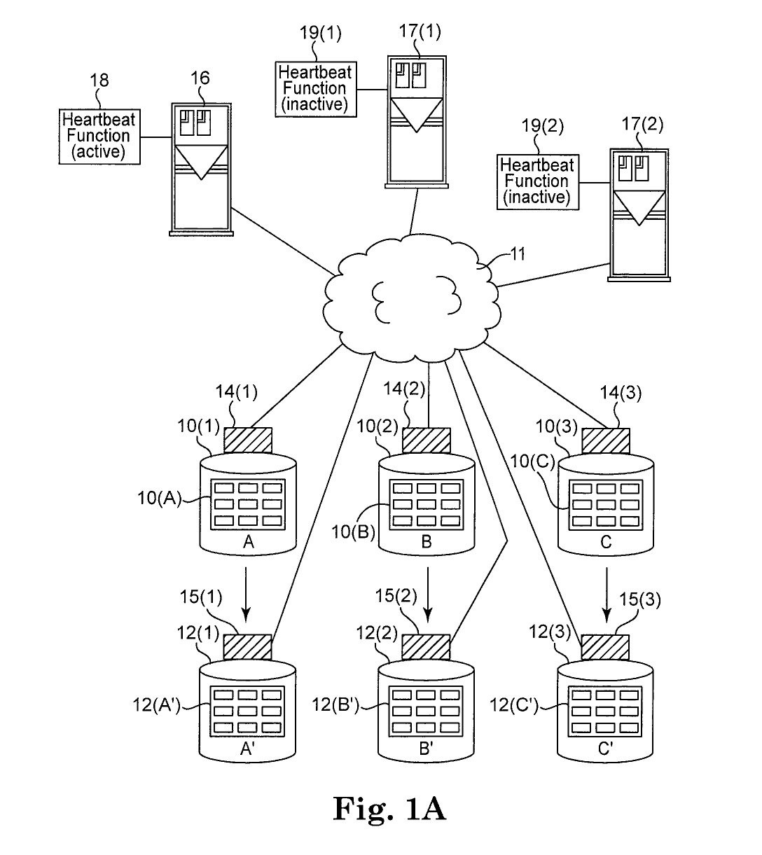

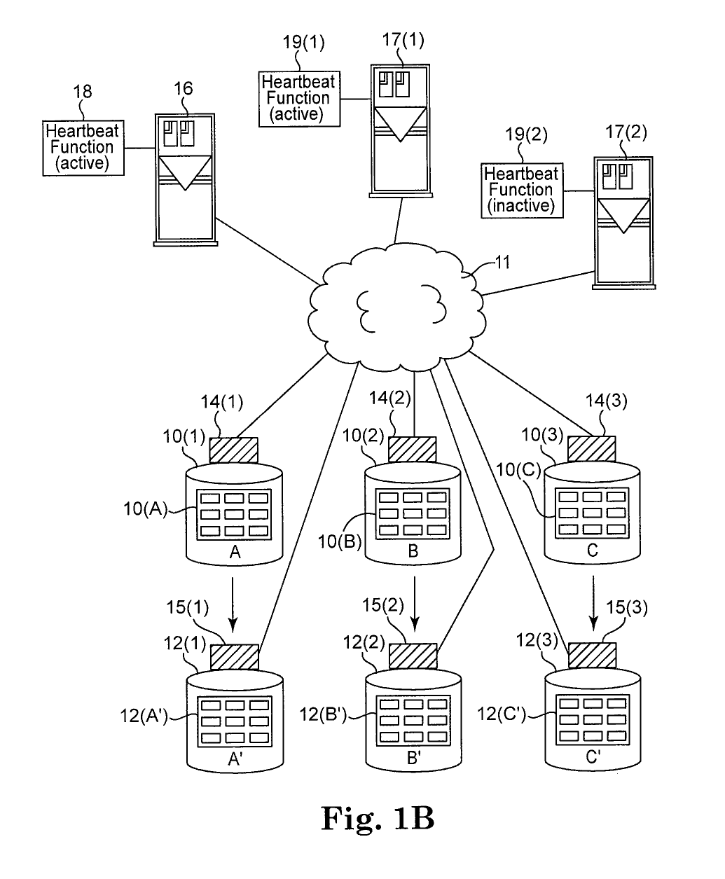

One embodiment of the present invention which is depicted in FIG. 1A provides for an array of source storage devices 10(1)-10(3) connected over a network 11 to corresponding target storage devices 12(1)-12(3). Each source storage device may be replicated to any number of target storage devices, but a common configuration depicted in FIG. 1A shows each source storage device 10(1)-10(3) replicated to a single target device 12(1)-12(3) respectively. Each of the source storage devices 10(1)-10(3) contain volumes containing data files and objects 10(A)-10(C) which are replicated 12(A′)-12(C′) on the target storage devices 12(1)-12(3). Each of these storage devices further contain control units 14(1)-14(3) and 15(1)-15(3), commonly referred to as storage controllers, which manage the reading and writing of data on the corresponding storage device.

The source storage devices 12(1)-12(3) are further connected over the network 11 to a primary consistency manager 16. The primary consistency manager 16 may be implemented as a server which controls replication of data between the source storage devices 10(1)-10(3) and the target storage devices 12(1)-12(3). Additionally, a set of secondary consistency managers 17(1)-17(2) are connected on the network 11. At any single point in time, only one consistency manager is able to actively operate as the controlling consistency manager, depicted in FIG. 1A as the primary consistency manager 16. Thus, when the system starts its operation, only the primary consistency manager 16 actively manages the data replication process, although there may be numerous secondary consistency managers 17(1)-17(2) in a standby or inactive mode.

The primary consistency manager 16 contains a heartbeat function 18 which sends a heartbeat signal over the network 11 to the storage controllers 14(1)-14(3) controlling each source storage device 10(1)-10(3). The source storage devices 10(1)-10(3) are configured to suspend or “freeze” further writes to its storage disk if the source storage device storage controller 14(1)-14(3) does not receive a heartbeat signal within a predefined timeout period. The heartbeat function 18 being sent by the primary consistency manager server 16 sends the heartbeat at an interval which is less than the predefined timeout period. The receipt of the heartbeat helps notify the source storage devices 10(1)-10(3) that the primary consistency manager 16 is operating and data replication activities are continuing normally.

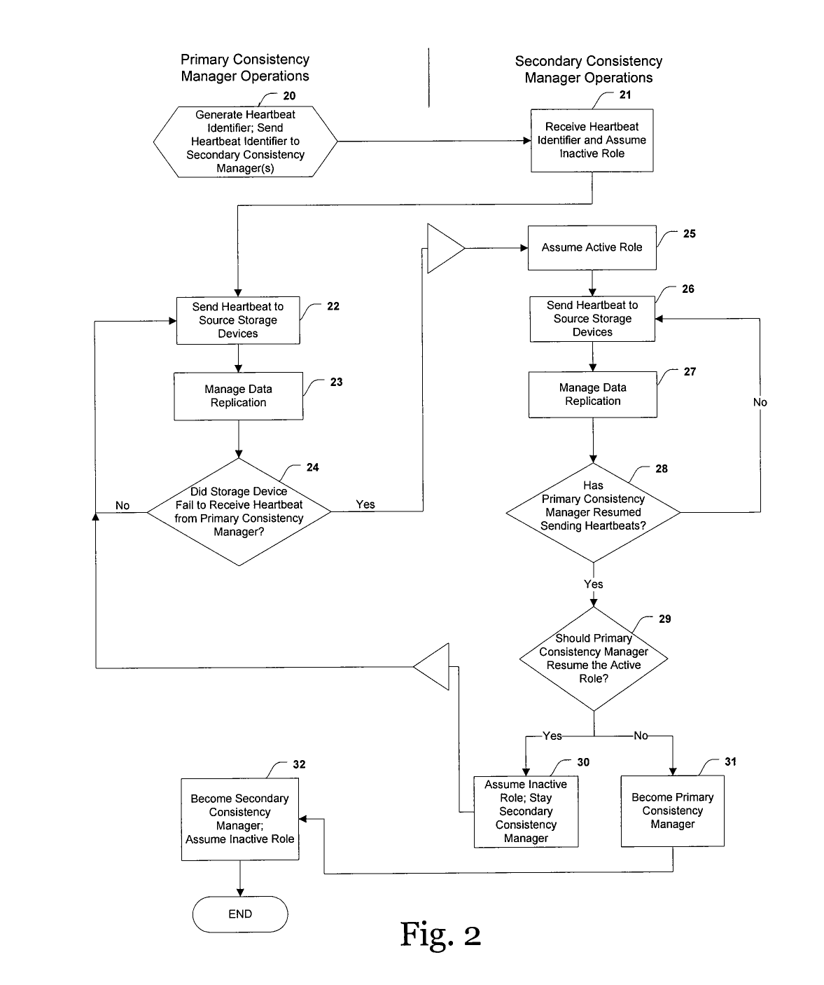

One embodiment of the operation of the high availability consistency heartbeat function is further depicted in FIG. 2. Although the process depicted in FIG. 2 shows the operations of only a single secondary consistency manager, two or more secondary consistency managers may be provided as desired. When the software instance operating on the primary consistency manager 16 starts up, a unique identifier is generated, with this unique identifier being used to identify the heartbeats sent to each source storage device storage controller 10(1)-10(3) as in step 20. Additionally, as part of setting the high availability relationship between the plurality of consistency managers, the primary consistency server 16 sends the heartbeat identifier to the secondary consistency managers 17(1)-17(2) as in step 20 so that the secondary consistency managers are aware of which heartbeat is active and running. The heartbeat identifier will be later used by the secondary consistency manager in the event that the primary consistency manager 16 is unable to successfully send heartbeats to the source storage devices 10(1)-10(3).

Although one consistency manager is able to control numerous storage devices, having multiple consistency managers helps prevent data replication failure if the active consistency manager is unable to communicate with the storage devices. Thus, when the primary consistency manager is properly operating, each of the secondary consistency managers remains in an inactive, standby role as in step 21, waiting to become activated if needed.

When the primary consistency manager 16 is active and connected to the network, it is the only consistency manager that sends the heartbeat to the storage controller located in the storage devices, as in step 22. Additionally, the primary consistency manager is responsible for managing the data replication process as in step 23, sending commands as necessary to start, stop, or suspend the data replication from the source storage devices 10(1)-10(3) to the target storage devices 12(1)-12(3). The primary consistency server 16 does not need to keep track of the data on the storage devices, but it does ensure that the data is being replicated successfully by the storage devices by issuing commands to the storage devices to utilize various data replication mechanisms.

When the high availability connection is broken, such that a source storage device does not receive a heartbeat from the primary consistency manager as in step 24, the secondary consistency manager becomes active as depicted in step 25. FIG. 1B depicts this scenario, demonstrating a loss of the network connection to the primary consistency manager 16 and the activation of the heartbeat function 19(1) on one of the secondary consistency manager servers 17(1). As shown in steps 26-27, when the primary consistency manager is unable to send its heartbeat, one of the secondary consistency managers 17(1) assumes an active role, taking over the data replication management functions of the primary consistency manager, and sending the heartbeat to the storage controllers. The secondary consistency manager 17(1) immediately activates its heartbeat function 19(1) to continue sending the heartbeat where the old primary consistency manager 16 left off. A seamless transfer occurs to ensure there is no interruption to the data replication solution.

As previously described, during normal operation, the primary consistency manager 16 sends a heartbeat containing an unique identifier to the source storage device storage controllers. When the primary consistency manager 16 loses its connection to the source storage device storage controllers 14(1)-14(3) as depicted in FIG. 1B, one of the secondary consistency manager servers 17(1) becomes active and takes over the heartbeat function. This heartbeat sent from the now-active secondary consistency manager heartbeat function 19(1) contains the same identifier as previously used by the primary consistency manager 16. Since the heartbeat contains the same identifier, the storage controllers 14(1)-14(3) do not realize that the primary consistency manager 16 is no longer operating. Thus, the secondary consistency manager 17(1) undertakes the active, controlling role of a primary consistency manager to continue replicating data on the storage device servers.

The primary consistency manager 16 may have had its heartbeat interrupted due to some minor disruption, such as temporarily losing a network connection. In this case, when the primary consistency manager 16 returns to the network, it is still active and will resume sending its heartbeats to the storage controllers 14(1)-14(3), as in step 28. At this point, there are two active servers sending a heartbeat with the same identifier to the source storage device storage controllers. A user or an automated process is able to see that the high availability connection was interrupted, and the high availability connection can be set up again. As shown in step 29, a decision may be made, either automated or by the user, to return the primary consistency manager 16 into the active, controlling role as in step 30, or to swap roles of the primary consistency manager 16 and the newly-activated secondary consistency manager 17(1) as in steps 31-32.

As shown in step 30, the user or the automated process may choose to keep the primary consistency manager active, and de-activate the newly-activated secondary consistency manager. The newly-activated secondary consistency manager then assumes an inactive role, and allows the primary consistency manager to resume its management of data replication activities. If the user or the automated process chooses to place the now-active secondary consistency manager 17(1) back into a standby mode, the secondary consistency manager stops issuing heartbeats to any storage controllers until it becomes active again.

If, however, the primary consistency manager 16 shut down due to a power failure or a similar cause which requires the server to restart, then when the primary consistency manager 16 returns to the network and sends heartbeats as in step 28, the primary consistency manager 16 will send a new unique heartbeat identifier. The storage controllers 14(1)-14(3) will then treat the primary and secondary consistency manager servers as different servers, because the primary consistency manager database was potentially erased or modified and the same replication data may not be controlled by the newly-restarted primary consistency manager. Again, a user or an automated process can determine as in step 29 whether to return the primary consistency manager 16 to its active, controlling role and return the secondary consistency manager to an inactive role as in step 30.

Alternately, as shown in step 31, the secondary consistency manager may keep operating in an active role and become the controlling primary consistency manager. This results in the former primary consistency manager being inactivated, and becoming a secondary consistency manager as in step 32. This allows the process to restart in its entirety, where the inactive, secondary consistency managers are waiting to become active upon the failure of the primary consistency manager.

By employing a heartbeat signal with a shared heartbeat identifier across the network, multiple consistency managers can operate to control the same storage devices at different points in time without interrupting the storage management software or the data replication process. This also facilitates the ability to have multiple consistency manager instances use a single heartbeat, allowing the storage controllers to monitor for only a single heartbeat.

Although various representative embodiments of this invention have been described above with a certain degree of particularity, those skilled in the art could make numerous alterations to the disclosed embodiments without departing from the spirit or scope of the inventive subject matter set forth in the specification and claims.

What is claimed is:

1. A method in a computer system for providing highly available multiple storage system consistency, comprising:
providing a primary consistency manager and one or more secondary consistency managers connected on a network, wherein the primary consistency manager sends a signal containing a signal identifier at a predefined interval;
providing one or more source storage devices corresponding to one or more target storage devices connected on the network, wherein each source storage device contains a storage controller, and each source storage device storage controller is configured to receive the signal originating from the primary consistency manager;
utilizing the primary consistency manager to manage data replication between the one or more source storage devices and its one or more corresponding target storage devices, wherein the data replication between the one or more source storage devices and the one or more corresponding target storage devices is paused when the signal originating from the primary consistency manager is not received within a predefined timeout duration; and
utilizing one of the one or more secondary consistency managers to perform actions previously performed by the primary consistency manager if the primary consistency manager fails to send its signal to the one or more source storage devices, including sending to each of the source storage device storage controllers a signal containing a signal identifier identical to the signal identifier previously sent by the primary consistency manager.

2. The method as described in claim 1, wherein the secondary consistency manager which is performing the actions previously performed by the primary consistency manager assumes an active consistency manager role after the primary consistency manager fails to send its signal to the one or more source storage devices, including managing data replication between the one or more source storage devices and the one or more corresponding target storage devices.

3. The method as described in claim 1, wherein the primary consistency manager resumes an active consistency manager role after failing to send its signal to the one or more source storage devices, including resuming management of data replication between the one or more source storage devices and the one or more corresponding target storage devices and sending a signal containing the signal identifier of the previous primary storage management server, and wherein the secondary consistency manager which is performing the actions previously performed by the primary consistency manager resumes its inactive consistency manager role and stops sending the signal.

4. A system, comprising:
at least one processor; and
at least one memory storing instructions operable with the at least one processor for providing highly available multiple storage system consistency, the instructions being executed for:
providing a primary consistency manager and one or more secondary consistency managers connected on a network, wherein the primary consistency manager sends a signal containing a signal identifier at a predefined interval;
providing one or more source storage devices corresponding to one or more target storage devices connected on the network, wherein each source storage device contains a storage controller, and each source storage device storage controller is configured to receive the signal originating from the primary consistency manager;
utilizing the primary consistency manager to manage data replication between the one or more source storage devices and its one or more corresponding target storage devices, wherein the data replication between the one or more source storage devices and the one or more corresponding target storage devices is paused when the signal originating from the primary consistency manager is not received within a predefined timeout duration; and
utilizing one of the one or more secondary consistency managers to perform actions previously performed by the primary consistency manager if the primary consistency manager fails to send its signal to the one or more source storage devices, including sending to each of the source storage device storage controllers a signal containing a signal identifier identical to the signal identifier previously sent by the primary consistency manager.
